(19) United States
(12) Patent Application Publication
(10) Pub. No.: US 2008/0299518 A1
(43) Pub. Date: Dec. 4, 2008

(54) Artificial socket bone

(76) Inventor: Katsunari Nishihara, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/888,727

(22) Filed: Aug. 2, 2007

(30) Foreign Application Priority Data
May 29, 2007 (JP) 2007-141641

(51) Int. Cl. A61C 13/08; A61C 8/00

(52) U.S. Cl. 433/202.1; 433/201.1

(57) ABSTRACT

An artificial socket bone used as an outer cover wholly or partially encapsulating an artificial dental root, wherein the artificial socket bone is formed in a substantially cylindrical tubular shape, with protrusions being formed through a plurality of cuts in the surface of the artificial socket bone, part or all of the protrusions being curved inwards and/or outwards of the artificial socket bone. Some of the cuts are through-holes, which have no protrusions, for letting through cells that differentiate into alveolar bone proper and bone trabeculae.

### FIELD OF THE INVENTION

The present invention relates to an artificial socket bone for stably implanting an artificial dental root and for promoting differentiation of the cells that make up the alveolar bone proper around the artificial dental root.

### DESCRIPTION OF THE RELATED ART

In order to support the mechanical functions of teeth, i.e. mastication and occlusion (biting), over long periods of time (60 to 80 years), humans are provided with a special structure comprising three kinds of periodontal support tissue that supports the teeth, namely 1) cementum (fibrous bone), 2) the periodontal ligament joint (dental root membrane) and 3) the alveolar bone proper (socket bone). The alveolar bone proper (socket bone) fixes the tooth to the socket bone and functions as a cushion bringing the two into contact. The surfaces of the dental root and the alveolar bone proper are fixed by cementum to the dental root membrane. At the position where the alveolar bone proper (socket bone) joins the jawbone, there exist bone trabeculae attached to the alveolar bone proper (socket bone).

Recovery of missing teeth through direct implant in the jawbone of artificial dental roots, instead of plate dentures, is a procedure that has been being carried out for several years in the field of dental implants. Herein, attaching an artificial dental root to the jawbone by ankylosis or osseointegration, without a buffering mechanism, is problematic as this can result in, for instance, breakage of the artificial dental root or breakage of the surrounding bone, by dint of repeated mastication.

Therefore, the applicants invented an artificial dental root disclosed in Japanese Patent No. 2547953. In such an artificial dental root, the Mises equivalent stress distributed in surrounding bone is significantly evenly distributed, such that outstanding bone growth is produced in a range of distribution, amounting to one-hundredth to one-tenth of the maximum stress value and ten times to tens of times of the minimum stress value. This is possibly ascribable to the piezoelectric current, streaming potential and to the fluidity of bone forming factors.

When the artificial dental root according to Japanese Patent No. 2547953 is implanted, the principal stress trajectories thereof, which are dependant on the shape of the root, become distributed around the artificial dental root. Bone forms along the principal stress trajectories, as a result of the vibrations caused due to recurrent masticatory motion. According to the analysis of the distribution of principal stress trajectories of artificial dental roots of the fibrous connective-tissue attachment type, the dental root first withstands the stress, and then the principal stress trajectories are each converted into two entirely different components perpendicular to each other on the periodontal fibrous tissue. The advance of these principal stress trajectories, coupled with vibration, gives rise to alveolar bone proper (socket bone) A that forms around the artificial dental root as illustrated in FIG. 7. On the other hand, the substantially perpendicular principal stress trajectories attached to the alveolar bone proper (socket bone) A give rise to the formation of bone trabeculae B adhered to the alveolar bone proper (socket bone) A.

When the alveolar bone proper (socket bone) A and the bone trabeculae B become wholly formed through the above mechanical stimuli, the artificial dental root can then withstand not only intermittently strong occlusal forces but also lasting occlusal forces and/or lateral forces. However, complete formation of the alveolar bone proper (socket bone) A and the bone trabeculae B takes considerable time. It is therefore desirable to form alveolar bone proper (socket bone) A and the bone trabeculae B simultaneously with the implant of an artificial dental root.

Alveolar bone proper (socket bone) A and the bone trabeculae B become formed after recurrent mastication over quite a number of times, but bone trabeculae do not form immediately after implant, which is problematic in that the artificial dental root is not stable, in particular, during an initial stage.

### SUMMARY OF THE INVENTION

An object of the invention is to artificially form an outer cover corresponding to the alveolar bone proper (socket bone) between an implanted artificial dental root and the jawbone, to encapsulate the artificial dental root and stably implant the artificial dental root at the same time.

Since induction of the alveolar bone proper (socket bone) through the mechanical energy of mastication is time-consuming, another object of the invention is to create bone tissue speedily through induction of osteogenesis and hemopoiesis by artificially forming an outer cover around the alveolar bone proper (socket bone), and stimulating mechanically undifferentiated mesenchymal cells.

The present invention adopts the following constitutions with a view of solving the above problems.

(1) An artificial socket bone used as an outer cover wholly or partially encapsulating an artificial dental root, wherein the artificial socket bone is formed in a substantially cylindrical tubular shape, with protrusions being formed through a plurality of cuts or incisions made in the surface of the artificial socket bone, part or all of the protrusions being curved inwards and/or outwards of the artificial socket bone.

(2) The artificial socket bone according to (1) above, wherein the artificial socket bone is formed by any one among metals, alloys, resins and ceramics which are biocompatible. The biocompatible metal may be, for instance, Ti or the like. The alloy may be, for instance, a Ti alloy or the like. The resin is preferably a polylactic acid resin or the like. Preferably, the resin is a mixture of one or more among compounds of polylactic acid of vegetable origin to which aliphatic ester of glycerin is added, copolymers of polylactic acid of vegetable origin and diol/dicarboxylic acid, and polyesters of starch.

(3) The artificial socket bone according to (1) or (2) above, wherein the cuts are formed equidistantly in a plurality of rows along the cylindrical tubular peripheral face of the artificial socket bone and in each of the rows at least two cuts are arranged spaced apart in the up-and-down direction of the artificial socket bone such that all the protrusions in at least one row in the up-and-down direction are curved inwards of the artificial socket bone, while in a row or rows adjacent to the at least one row the cut protrusions are curved outwards of the artificial socket bone.

(4) The artificial socket bone according to any of (1) through (3) above, wherein some of the cuts are through-holes, which have no protrusions, for letting through cells that differentiate into alveolar bone proper and bone trabeculae.

Throughout this specification, the term “cut protrusions” is used to mean the above protrusions at the cut portions.

The present invention affords the effect of artificially forming an outer cover corresponding to the alveolar bone proper (socket bone) between an implanted artificial dental root and the jawbone, and thereby encapsulating the artificial dental root and stably implanting it at the same time.

The invention affords also the effect of creating bone tissue speedily through induction of osteogenesis and hemopoiesis by stimulating mechanically undifferentiated mesenchymal cells.

### BRIEF DESCRIPTION OF THE DRAWINGS

FIG. 1 is a perspective view diagram illustrating an artificial socket bone according to Embodiment 1.

FIG. 2 is a schematic diagram illustrating the artificial socket bone according to Embodiment 1 and an artificial dental root embedded in the jawbone.

FIG. 3 is a perspective view diagram illustrating an artificial socket bone according to Embodiment 2.

FIG. 4 is a schematic diagram illustrating the state when the artificial socket bone, shown by a cross-sectional diagram along the arrow IV-IV of the artificial socket bone of FIG. 3, and the artificial dental root are embedded in the jawbone.

FIG. 5A is a diagram illustrating a plate used in an artificial socket bone according to the present invention and FIG. 5B is a diagram illustrating another example of the plate.

FIG. 6 is a perspective view illustrating an example of an embodiment of an artificial socket bone according to the present invention.

FIG. 7 is a schematic diagram for explaining the formation process of alveolar bone proper A and bone trabeculae B.

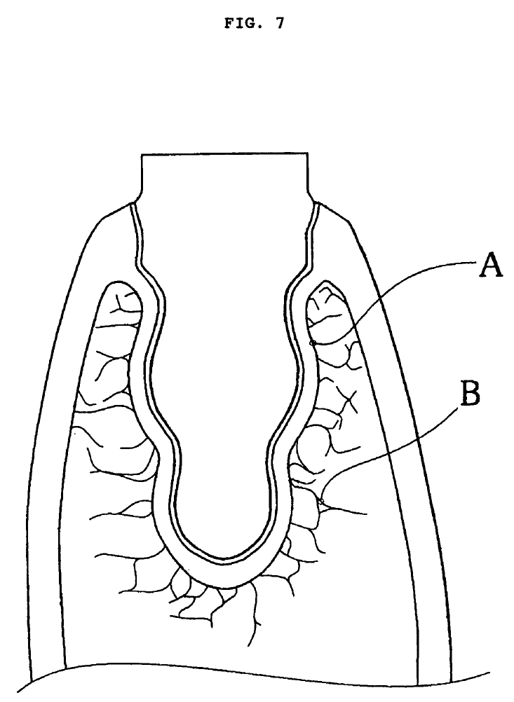

### DETAILED DESCRIPTION OF THE PREFERRED EMBODIMENTS

Embodiments of the artificial socket bone according to the present invention are explained in detail next.

The artificial socket bone according to the present embodiment can be manufactured in accordance with the manufacturing method below. The invention is not limited to the following method, which is merely an illustrative example.

In the preparation of the artificial socket bone according to the present invention, a cylindrical blank of a material such as Ti or the like which has been processed into a cylindrical shape is formed into a cylindrical tubular shape by being subjected to cutting work. Then, using laser, plural cuts are made in the surface of the tubular material. The cuts, which are circular, elliptical, rectangular, square or the like, partially connect to the cylindrical body. In the case, for instance, of longitudinally elongated cuts, incisions are made in the left and right sides, and on the upper or lower side. When the incisions are made in the upper side, the cuts are joined to the cylindrical body without incisions being made in the lower side, while when the incisions are made in the lower side, it is the upper side that is joined with the cylindrical body. After making such incisions, the cut portions are processed to protrude from the incision-free portions as the starting points, and the entire cuts are curved to form protrusions.

In an alternative manufacturing method, the artificial socket bone according to the present embodiment can be formed by bending a single plate into a cylindrical tubular shape. Cuts are then made into the plate, using a milling cutter, laser or the like. Also, cuts can also be formed in the plate by a forging method using a die.

The plate with the cuts made therein is then bent into a cylindrical tubular shape, and the end portions are joined together through welding or using an adhesive. The adhesive is preferably an adhesive having a biodegradable plastic resin comprising polylactic acid as a raw material thereof. The adhesive includes, for instance, protein-rubber latexes, polyvinyl butyral, neoprene, butadiene-acrylonitrile synthetic resins or the like. The joining portion, in particular, is preferably formed by an adhesive having a plastic resin as a raw material. Yet more preferably, the joining portion is formed by an adhesive having, as a raw material thereof, a biodegradable plastic resin comprising polylactic acid.

Maize and/or sugarcane, used as the raw material of the polylactic acid, absorb carbon dioxide during their growth, and can be reclaimed by combustion after use. These materials are harmless to humans, and hence are optimal materials for the artificial alveolar bone proper according to the present invention. When the ends are joined using an adhesive, the artificial socket bone has preferably a function of exerting a resilient bouncing force in the outward direction.

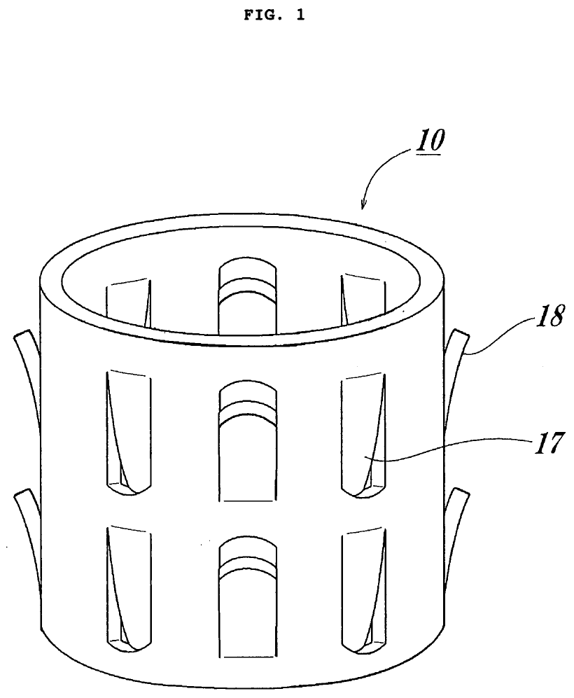

The above-mentioned cuts are preferably provided equidistantly along the cylindrical tubular peripheral face. Preferably, as shown in FIG. 1, the cut protrusions in at least one row along the axial direction are curved inwards of the artificial socket bone, while the cut protrusions in a row or rows adjacent to the above at least one row are curved outwards of the artificial socket bone. The protrusions curved inwards become fixed to the outer periphery of the artificial dental root, while the protrusions curved outwards become fixed to the jawbone.

Preferably, some of the cuts are through-holes, having no protrusions, for letting through cells that differentiate into alveolar bone proper (socket bone) and bone trabeculae. Such through-holes may be formed, for instance, by severing of the connecting portion of the cut, or by opening holes shaped differently than the cut, using laser or the like.

Forming through-holes in the surface of the artificial socket bone allows letting through cells that differentiate into alveolar bone proper (socket bone) and bone trabeculae. This allows inducing osteogenesis and hemopoiesis effects around the inner dental root. The induction of an osteogenesis effect causes undifferentiated mesenchymal cells to differentiate into alveolar bone proper (socket bone) and bone trabeculae. In the periodontal ligament, moreover, the stress derived from masticatory forces is transformed into two perpendicular principal stress trajectories having wholly different vectors.

Among the transformed principal stress trajectories, the trajectories parallel to the axial direction on the surface of the inner dental root give rise to alveolar bone proper (socket bone), while the perpendicularly running trajectories give rise to bone trabeculae. The principal stress trajectories running over the alveolar bone proper (socket bone) terminate at the joint thereof with the cortical bone.

The thickness of the artificial socket bone ranges preferably from 0.1 to 0.2 mm. A thickness below 0.1 mm may result in insufficient resilient bouncing force. On the other hand, a thickness exceeding 0.2 mm may result in corrosion of the artificial alveolar bone proper over the years.

The artificial socket bone is preferably formed of Ti or a Ti alloy. Ti and Ti alloys have extremely low hazardousness towards organisms, and have good biocompatibility, being therefore preferable as a material of the artificial socket bone. They are also preferable in terms of cost.

The protrusions curved outward have the function of creating a resilient bouncing force in the peripheral direction of the cylindrical tube. That is, the artificial socket bone is compressed toward the tubular inner direction through gripping of the outward-pointing protrusions from outside.

The material used as the artificial dental root includes metals, simple substances, alloys, ceramic, cermets, bioglass, plastics, as well as composites of the foregoing.

Preferred metals of the artificial dental root include pure Ti and/or Ti alloys, in particular pure Ti. That is because pure Ti has extremely low hazardousness towards organisms, and has good biocompatibility. Also, further research was made directed at realizing artificial dental roots of Ti-based shape memory alloys, since fixation after implant could be advantageously facilitated by using a Ti-based shape memory alloy. Among these, Ti—Pd shape memory alloys comprising, as main components, Pd, which has been employed for years in dental roots, and Ti, having excellent corrosion resistance, can be used as materials for artificial dental roots having low bio-hazardousness.

A buffering material is preferably further provided between the artificial socket bone and the artificial dental root. Buffering materials that can be used include, for instance, plastic adhesives, cermets and the like, for instance Superbond™, cement phosphate, Panavia™ and the like. Interposing a buffering material between the artificial socket bone and the artificial dental root has the effect of transforming the principal stress trajectory which, coupled with a shock-absorbing effect, eliminates the tendency of bone to break as a result of occlusal forces.

An example of an embodiment according to the present invention is explained next with reference to accompanying drawings. The present invention is not limited to the embodiment below.

### Embodiment 1

An artificial socket bone 10 according to the present embodiment, illustrated in FIG. 1, is formed to a cylindrical tubular shape having plural cuts made in the cylindrical tubular surface thereof, with protrusions 17 and 18 being formed as a result of such cuts. These protrusions include protrusions 17 protruding into the artificial socket bone and protrusions 18 bending out of the artificial socket bone.

The above plural cuts are provided equidistantly along the peripheral face of the cylindrical tube, and are arrayed equidistantly also in the axial direction. There are eight rows of protrusions spaced apart in the peripheral face direction. The protrusions 17 of cuts in some rows curve into the artificial socket bone 10, while the protrusions 18 of cuts, in rows adjacent to the former, curve out of the artificial socket bone.

The artificial socket bone fits into an implant hole for dental roots opened in the jawbone. Herein, the protrusions 18 of the artificial socket bone are caught on the inner peripheral face of the implant hole for dental roots, whereby the artificial socket bone becomes held fast within the implant hole.

The protrusions 17 of the artificial socket bone 10 come into contact with an artificial dental root, not shown in the figure, such that the artificial dental root can become held fast by being caught by the protrusions 17 as a result of the resilient bouncing force or engaging force of the latter.

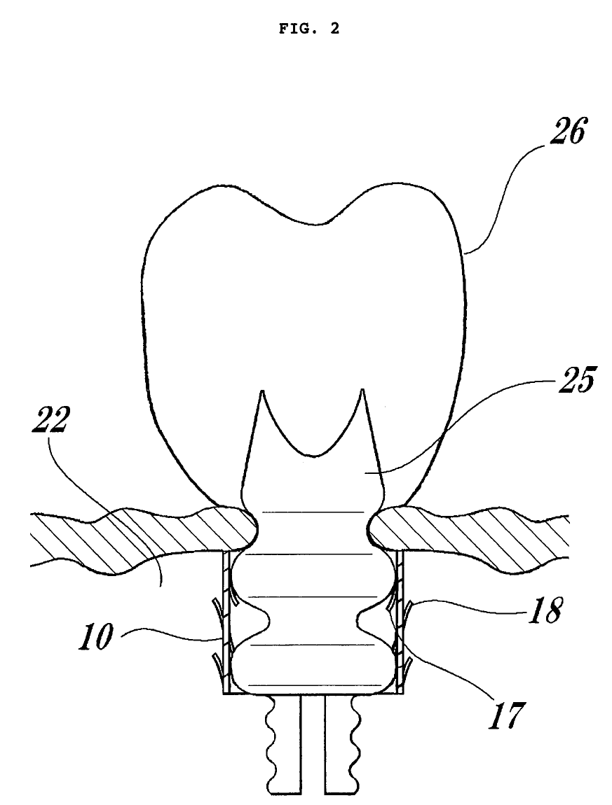

FIG. 2 is a schematic diagram illustrating an example using an artificial socket bone according to the Embodiment 1.

As illustrated in FIG. 2, the artificial socket bone 10 used in the present Embodiment 1 is used embedded into an implant hole for implanting an artificial dental root, the hole being opened in a jawbone 22. The protrusions 18 in the artificial socket bone 10 are caught on the inner peripheral face of the implant hole of the jawbone, whereby the artificial socket bone 10 can be held fast.

The artificial socket bone 10 serves as an outer cover for encapsulating an artificial dental root 25 which supports a dental crown 26. As illustrated in FIG. 2, the protrusions 17 of the artificial socket bone 10 are caught on a protuberance at the base of the artificial dental root 25, so that the artificial dental root 25 can be held thanks to the resilient bouncing force of the protrusions 17.

### Embodiment 2

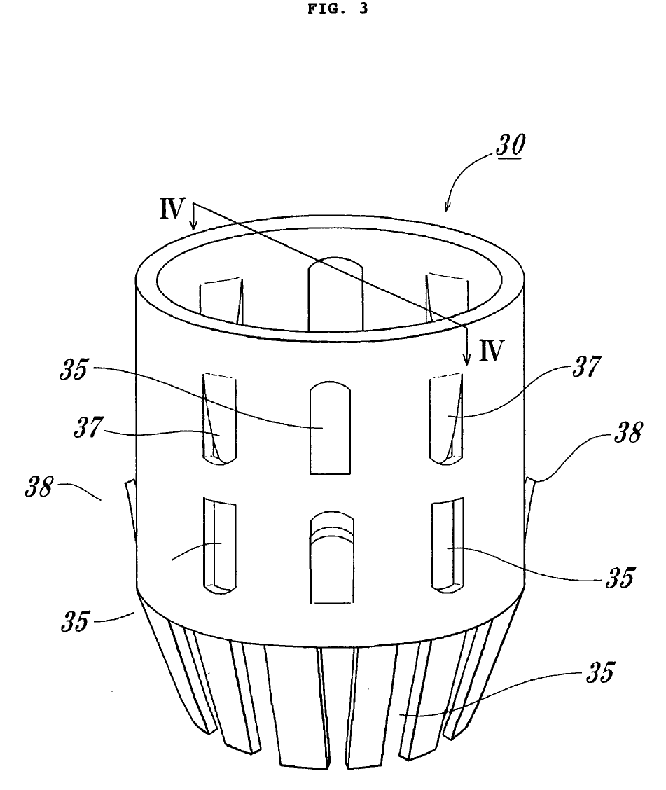

As illustrated in FIG. 3, an artificial socket bone 30 according to the present embodiment is formed in a cylindrical tubular shape having plural cuts made in the cylindrical tubular surface thereof, with protrusions 37 and 38 being formed from such cuts. These protrusions include protrusions 37 protruding into the artificial socket bone and protrusions 38 bending out of the artificial socket bone.

The above plural cuts are provided equidistantly along the peripheral face of the tube, and are arrayed equidistantly also in the axial direction. There are eight rows of protrusions spaced apart in the peripheral face direction. The protrusions 37 of cuts in some rows curve into the artificial socket bone 30, while the protrusions 38 of cuts, in a row or rows adjacent to the former, curve out of the artificial socket bone.

Moreover, the artificial socket bone according to Embodiment 2 comprises through-holes 35 wherein part of the above cuts have no protrusions, such that cells differentiating into alveolar bone proper and bone trabeculae pass through these through-holes 35. As illustrated in FIG. 3, the through-holes 35 may be provided on the outer peripheral face of the cylindrical tube or on the outer periphery of the bottom thereof.

The artificial socket bone 30 fits into an implant hole for dental roots opened in the jawbone. Herein, the protrusions 38 of the artificial socket bone are caught on the inner peripheral face of the implant hole for dental roots, whereby the artificial socket bone 30 becomes held fast within the implant hole.

The protrusions 37 of the artificial socket bone 30 come into contact with an artificial dental root, not shown in the figure, such that the artificial dental root can become held fast by being caught by the protrusions 37 as a result of the resilient bouncing force or engaging force of the protrusions 37.

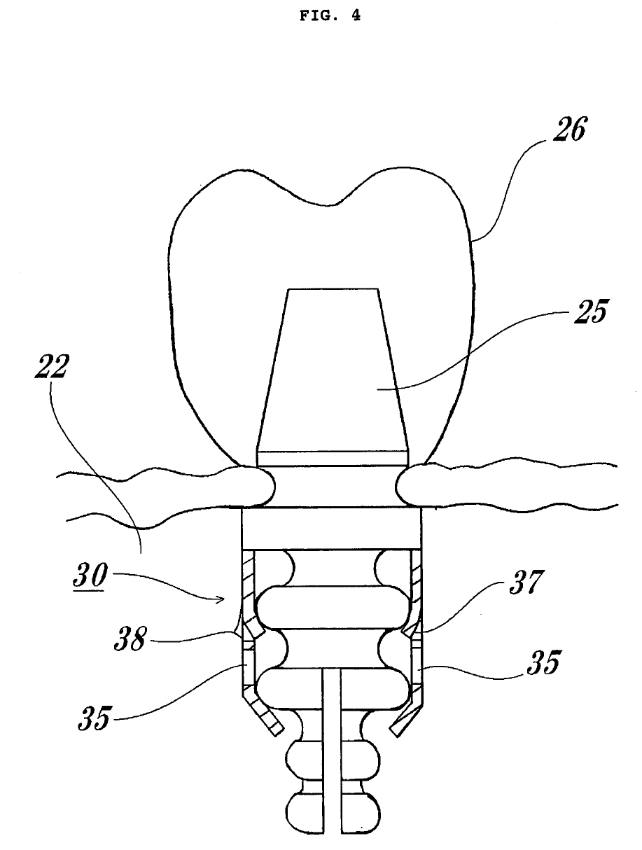

FIG. 4 is a schematic diagram illustrating an example using the artificial socket bone 30 according to Embodiment 2. Parts identical to those of FIG. 2 are denoted with identical reference numerals.

As illustrated in FIG. 4, the artificial socket bone 30 according to Embodiment 2 is used embedded into an implant hole for implanting an artificial dental root, the hole being opened in a jawbone 22.

The artificial socket bone 30 serves as an outer cover for encapsulating an artificial dental root 25 which supports a dental crown 26. As illustrated in FIG. 4, the protrusions 37 of the artificial socket bone 30 are caught on a protuberance at the base of the artificial dental root 25, so that the artificial dental root 25 can be held thanks to the resilient bouncing force of the protrusions 37.

The through-holes 35 formed in the surface of the artificial socket bone allow cells differentiating into alveolar bone proper (socket bone) and bone trabeculae to pass through the artificial socket bone. This allows inducing osteogenesis and hemopoiesis effects around the dental root within the artificial socket bone. The induction of the osteogenesis effect results in the differentiation of undifferentiated mesenchymal cells into alveolar bone proper (socket bone) and bone trabeculae.

As the artificial dental root 25 there can be used, for instance, an “Abutment 2.5” (one-piece long type, Ø 6.5 mm, by Nitto Co.) made of Ti.

Since in order to encapsulate the artificial dental root 25 within the artificial socket bone (artificial alveolar bone proper) 30 according to the present embodiment in the above-mentioned manner, plural through-holes 35 are formed on the artificial socket bone 30, undifferentiated mesenchymal cells that are present in the periphery of the artificial socket bone 30 are taken up onto the peripheral face of the artificial dental root. Mastication further activates then the osteogenesis effect, and undifferentiated mesenchymal cells are taken up onto the peripheral face of the dental root within the artificial socket bone, whereupon alveolar bone proper and bone trabeculae can form rapidly around the dental root within the artificial socket bone. The artificial socket bone 30 according to the present invention is firmly implanted in the implant hole, and hence does not wiggle as a result of mastication.

### Embodiment 3

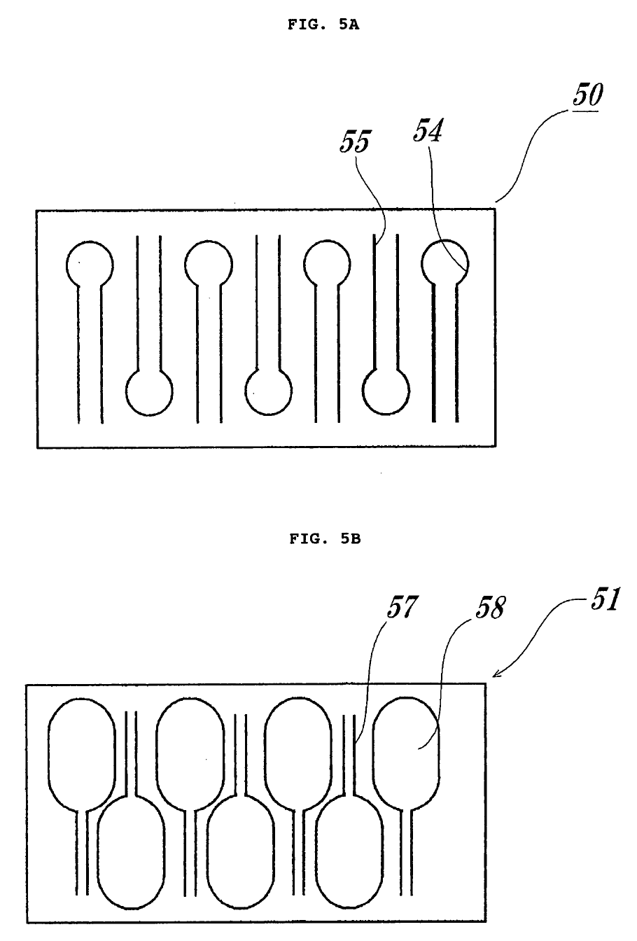

FIG. 5A and FIG. 5B show two embodiments, each showing a single sheet of a plate material 50 or 51 used in the artificial socket bone according to the present invention. A titanium alloy can be used herein as the plate material. As illustrated in FIGS. 5A and 5B, the cuts are formed in the plate material pointing alternately up and down.

The cuts 55 in the plate material 50 illustrated in FIG. 5A are substantially rectangular and have ends 54 that are punched to a circular shape. The plate material 50 may also be shaped as illustrated in FIG. 5B. The cuts 57 in the plate material 51 illustrated in FIG. 5B are substantially rectangular and have ends 58 that are configured to a deformed elliptical shape. These cuts 55, 57 and the ends 54, 58 are curved inwards or outwards to yield the protrusions of the present invention.

Also, forming through-holes by cutting from the upper or lower side with determined spacings along the axial direction of the tube allows distributing the bending moment, which is advantageous for facilitating bending during formation of the tube, and for preventing the formation of fissures.

The ends of the cuts are preferably shaped as a circular arc. Shaping the ends as a circular arc has the effect of dispersing stresses, which allows preventing the formation of cracks at the ends.

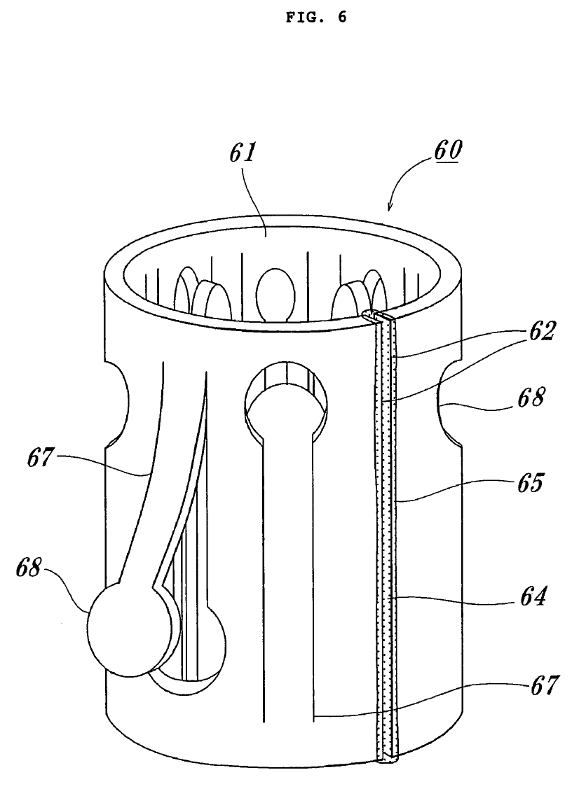

FIG. 6 is a perspective view illustrating an artificial socket bone 60 according to the present invention. FIG. 6 illustrates another embodiment where the number of cuts, etc differs from the plate material illustrated in FIG. 1. The artificial socket bone according to the present invention illustrated in FIG. 6 is tubular, and is formed by bending one sheet of plate material into a cylindrical tube.

The ends 62, 62 of one sheet of plate material abut each other with a predetermined gap. The ends 62, 62 may also be joined without such a gap in between. A joining portion 64 forms thus at the portion where the ends abut each other, with an adhesive 65 being applied over the entire surface of the joining portion 64. The joining portion 64 is formed by an adhesive having a biodegradable plastic resin as a raw material. The biodegradable plastic resin has preferably polylactic acid as a main constituent.

The artificial socket bone according to the present invention has formed on the cylindrical tubular peripheral face thereof cuts 67 alternately pointing up and down in the axial direction. The ends 68 of the cuts 67 are shaped substantially as circles. Protrusions are thus formed by bending the cuts 67 and the ends 68 inwards or outwards.

The shape of the artificial socket bone 60 and the shape of the artificial dental root may vary somewhat depending on the implant location. At the apical areas, specifically, the shapes are round for anterior teeth, premolars and canines, and concaved in the center for molars by branching around them.

The joining portion 64 contracts when the artificial socket bone 60 is gripped from outside with a strong force. The artificial socket bone 60 is then placed, in that contracted state, into the implant hole which has been opened beforehand in the gum for implanting a dental root within the artificial socket bone.

The outer diameter of the artificial socket bone 60 before being gripped from the outer periphery is preferably larger than the inner diameter of the implant hole for implanting the dental root; also, the outer diameter of the artificial socket bone 60 must be smaller than the inner diameter of the implant hole, in the contracted state of the artificial socket bone 60 when gripped from outside.

After compressing thus the artificial socket bone 60 and placing it in the implant hole, the force in the outer periphery is removed, whereby the outward resilient bouncing force of the artificial socket bone 60 causes the latter to become stably fixed in the implant hole.

What is claimed is:

1. An artificial socket bone used as an outer cover wholly or partially encapsulating an artificial dental root, wherein the artificial socket bone is formed in a substantially cylindrical tubular shape, with protrusions being formed through a plurality of cuts in the surface of the artificial socket bone,
part or all of the protrusions being curved inwards and/or outwards of the artificial socket bone.

2. The artificial socket bone according to claim 1, wherein said artificial socket bone is formed by any one selected from the group consisting of metals, alloys, resins and ceramics which have biocompatibility.

3. The artificial socket bone according to claim 1, wherein said cuts are formed equidistantly in a plurality of rows along the cylindrical tubular peripheral face of the artificial socket bone and in each of the rows at least two cuts are arranged spaced apart in the up-and-down direction of the artificial socket bone such that all the protrusions in at least one row in the up-and-down direction are curved inwards of the artificial socket bone, while in a row or rows adjacent to said at least one row the cut protrusions are curved outwards of the artificial socket bone.

4. The artificial socket bone according to claim 1, wherein some of said cuts are through-holes, which have no protrusions, for letting through cells that differentiate into alveolar bone proper and bone trabeculae.
